(19) United States
(12) Patent Application Publication
(10) Pub. No.: US 2026/0313220 A1
(43) Pub. Date: Oct. 8, 2026

(54) VIDEO PROCESSING APPARATUS AND METHOD OF OPERATING THE SAME

(71) Applicant: HANWHA VISION CO., LTD., Seongnam-si (KR)

(72) Inventors: Jinsoo KIM, Seongnam-si (KR); Hyunsub KIM, Seongnam-si (KR); Dowon KO, Seongnam-si (KR); Hyojong SEO, Seongnam-si (KR); Jongkyung LEE, Seongnam-si (KR); Yongjun LEE, Seongnam-si (KR); Namkyoung KANG, Seongnam-si (KR); Chaewon LEE, Seongnam-si (KR)

(73) Assignee: HANWHA VISION CO., LTD., Seongnam-si (KR)

(21) Appl. No.: 19/636,127

(22) Filed: Apr. 1, 2026

(30) Foreign Application Priority Data
Apr. 4, 2025 (KR) 10-2025-0043927
Jun. 2, 2025 (KR) 10-2025-0072141

(51) Int. Cl. H04N 23/617

(52) U.S. Cl. CPC H04N 23/617

(57) ABSTRACT

A video processing apparatus may include a first circuit portion including a first computing device configured to process video data, and a second circuit portion including an interface on which a second computing device is removably mounted. The second circuit portion may include a power supply control circuit configured to, in response to a control signal, control power supplied to the second computing device; and an operation mode setting circuit configured to, in response to the control signal, set an operation mode of the second computing device selectively to a firmware update mode or a normal operation mode. In the firmware update mode, the first computing device is configured to perform updating a firmware of the second computing device while the power supplied to the first circuit portion is maintained and the second circuit portion is operable.

### CROSS-REFERENCE TO RELATED APPLICATIONS

This application is based on and claims priorities under 35 U.S.C. § 119 to Korean Patent Application No. 10-2025-0043927, filed on Apr. 4, 2025, and Korean Patent Application No. 10-2025-0072141, filed on Jun. 2, 2025, in the Korean Intellectual Property Office, the disclosures of which are incorporated herein in their entireties by reference.

### BACKGROUND

### FIELD

The disclosure relates to a video processing apparatus and a method of operating the same, and more particularly, to a video processing apparatus including a modular computing device and a method of operating the same.

### DESCRIPTION OF RELATED ART

Surveillance cameras installed for security purposes typically require functionality for detecting and analyzing an object within a surveillance area. Recent surveillance cameras may be provided with a built-in artificial intelligence (AI)-based video analysis function. The AI-based video analysis function may be used to detect and analyze an object in a surveillance video to provide an alarm to a user, and/or to provide an analysis attribute(s) associated with the surveillance video so that the user can conveniently search the surveillance video.

The AI-based video analysis function may be implemented in a camera System on Chip (SoC), or may be provided as a separate component mounted on a main board of a camera apart from the camera SoC.

However, when the AI-based video analysis function is implemented in a main camera SoC (or main SoC), the camera’s basic video processing functions and AI computing functions share computing resources, memory bandwidth, and power resources of the same SoC, which may cause problems such as system resource shortages, increased power consumption, increased heat generation, and degraded performance. In particular, such constraints may become more severe in an environment where multiple video channels are to be processed simultaneously, such as in a multi-directional camera (MDC). Furthermore, applying a higher-performance main SoC to mitigate this problem may lead to an increase in the overall cost of the device.

To address the problems with the main SoC, technologies have been proposed in which an AI chip or an AI SoC that exclusively processes AI functions is additionally mounted on the main board of the camera separately from the main camera SoC. However, in such a structure, the AI chip is often directly mounted on the main board or has a limited replacement structure, and thus hardware upgrades are practically difficult unless a higher-performance chip capable of pin-to-pin compatibility with an existing chip exists. As a result, the use of high-performance AI applications desired by the user may be restricted.

In addition, to overcome the limitations of hardware expandability, a technology in which an AI computing device is configured to be replaceable in a modular form may be considered. Even in this case, however, a separate jig board, an external control device, and/or a server environment may be required to write (flash) firmware to a new module and perform initial configuration in order to enable normal operation of the replaced new module. Therefore, maintenance procedures at an installation site may become complicated, and additional equipment and operational costs may increase.

FIG. 1 illustrates a related art surveillance camera. Referring to FIG. 1, a main camera SoC and an AI SoC for AI-based video processing are mounted together on a main board of the camera. In the structure in which the AI SoC is attached to the main board together with the main SoC as described above, hardware upgrades are impossible or highly limited unless a higher-performance chip capable of pin-to-pin compatibility with the corresponding AI SoC exists. Therefore, the use of AI applications desired by the user is inevitably restricted.

In addition, even if the AI SoC is mounted in a removable socket, the related art structure may require a procedure of cutting off power to the main board, replacing the existing AI SoC with a new AI SoC, reapplying power to the main board, and then flashing a firmware image for the newly mounted AI SoC using a flashing tool or the like stored in nonvolatile memory in order to upgrade the AI SoC. In this case, since the power of the entire surveillance camera may be cut off and/or normal surveillance functions may be interrupted while the AI chip is replaced or initialized, a critical security issue arises because the surveillance video of the surveillance area cannot be acquired during that time.

That is, the related art has limitations in that (i) embedding AI functions in the main SoC may cause various problems such as system resource shortage, heat generation, and cost increase, (ii) directly mounting a separate AI chip on the main board lacks upgrade flexibility, and (iii) employing a module-replacement structure may require separate external equipment and/or complex maintenance procedures.

The related art technology shown in FIG. 1 is merely an example for convenience of description, and the technical context forming the background of the disclosure is not limited thereto and may be similarly applied to various forms of related art video processing apparatuses or surveillance camera structures. In addition, the structure shown in FIG. 1 is merely an example configuration for explaining the background of the disclosure, and should not be construed to mean that the specific form shown in FIG. 1 or all thereof constitutes related art technology known in the technical field to which the disclosure pertains.

Furthermore, the above description is only intended to help understanding the background art related to the technical ideas of the disclosure, and therefore should not be construed as an admission that any of the foregoing constitutes prior art known to those skilled in the art.

Information disclosed in this Background section has already been known to the inventors before achieving the disclosure of the present application or is technical information acquired in the process of achieving the disclosure. Therefore, it may contain information that does not form the prior art that is already known to the public.

### SUMMARY

The disclosure has been made in view of the above-described problems, and an object of at least one embodiment of the disclosure is to provide a surveillance camera and a method of operating the same, wherein, while basic video acquisition and processing functions of the surveillance camera are maintained, power supplied to and/or an operation mode of a modular computing device mounted on an interface may be selectively controlled, thereby allowing a firmware update, a reboot, and/or a selective upgrade of the modular computing device to be performed without cutting off power to the entire surveillance camera.

Another object of at least one embodiment of the disclosure is to provide a surveillance camera and a method of operating the same, wherein modular computing devices having different performance levels and/or specifications may be selectively employed according to AI processing performance required by a user, without excessively increasing baseline specifications of a main board.

Another object of at least one embodiment of the disclosure is to provide a surveillance camera and a method of operating the same, wherein maintenance and performance expansion of a modular computing device may be more easily performed at an installation site while reducing dependence on a separate external jig device or complicated initialization equipment.

The objects to be achieved by the disclosure are not limited to those described above, and other objects not expressly described herein will be apparent to those skilled in the art from the following description.

According to an aspect of an example embodiment of the disclosure, a video processing apparatus, including: a first circuit portion including a first computing device configured to process video data received from an image sensor; and a second circuit portion configured to receive a control signal from the first circuit portion and including an interface on which a second computing device is removably mounted, wherein the second circuit portion includes: a power supply control circuit configured to, in response to the control signal, control power supplied to the second computing device through the interface, independently of power supplied to the first circuit portion; and an operation mode setting circuit configured to, in response to the control signal, set an operation mode of the second computing device selectively to a firmware update mode or a normal operation mode, wherein, in the firmware update mode, the first computing device is configured to perform updating a firmware of the second computing device while the power supplied to the first circuit portion is maintained and the second circuit portion is operable.

According to an aspect of an example embodiment of the disclosure, a video processing apparatus, including: an image sensor configured to acquire a video signal; a main board including a main computing device configured to transmit video data generated based on the video signal; and a connector board connected to the main board via a communication interface and including a socket on which a modular computing device is removably mounted, the modular computing device being configured to process the video data received from the main board via the communication interface, wherein the connector board includes: a power control logic configured to, in response to a control signal received from the main board via the communication interface, control power supplied through the socket to the modular computing device, independently of power supplied to the main board; and a mode setting logic configured to, in response to the control signal, set an operation mode of the modular computing device selectively to a firmware update mode or a normal operation mode, and wherein, in the firmware update mode, the connector board is configured to update a firmware of the modular computing device without physically separating the modular computing device from the socket, while the power supplied to the main board is maintained and the connector board is operable.

According to an aspect of an example embodiment of the disclosure, a method of operating a video processing apparatus, the method including: processing, by a first circuit portion, video data received from an image sensor; generating, by a first computing device of the first circuit portion, a control signal; controlling, by a power supply control circuit of a second circuit portion in response to the control signal, power supplied to a second computing device mounted on an interface of the second circuit portion; setting, by an operation mode setting circuit of the second circuit portion in response to the control signal, an operation mode of the second computing device selectively to a normal operation mode or a firmware update mode; and updating, by the first computing device in the firmware update mode, a firmware of the second computing device while power to the first circuit portion is maintained and a second circuit portion is operable.

### BRIEF DESCRIPTION OF DRAWINGS

The following drawings attached to this specification illustrate embodiments of the disclosure and serve to further understand the technical idea of the disclosure along with specific details for carrying out the disclosure. Therefore, the disclosure should not be interpreted as being limited to the details described in the drawings. The above and other aspects, features, and advantages of certain embodiments of the disclosure will be more apparent from the following description taken in conjunction with the accompanying drawings, in which:

FIG. 1 illustrates a related art surveillance camera.

FIG. 2 is a diagram schematically showing a surveillance camera system according to an embodiment.

FIGS. 3 and 4 are schematic block diagrams of the image processing device according to an embodiment.

FIG. 5 is a schematic block diagram of the network server according to an embodiment.

FIG. 6 is a diagram schematically showing a surveillance camera system according to an embodiment.

FIGS. 7A and 7B are diagrams schematically showing a surveillance camera system according to an embodiment.

FIG. 8 is a diagram schematically showing an AI server according to an embodiment.

FIG. 9 is a diagram schematically showing a cloud-based surveillance camera system according to an embodiment.

FIG. 10 is a diagram schematically showing a surveillance system according to an embodiment.

FIG. 11 is a schematic block diagram of a surveillance camera according to an embodiment.

FIG. 12 is a flowchart illustrating a method of operating a video processing apparatus according to an embodiment.

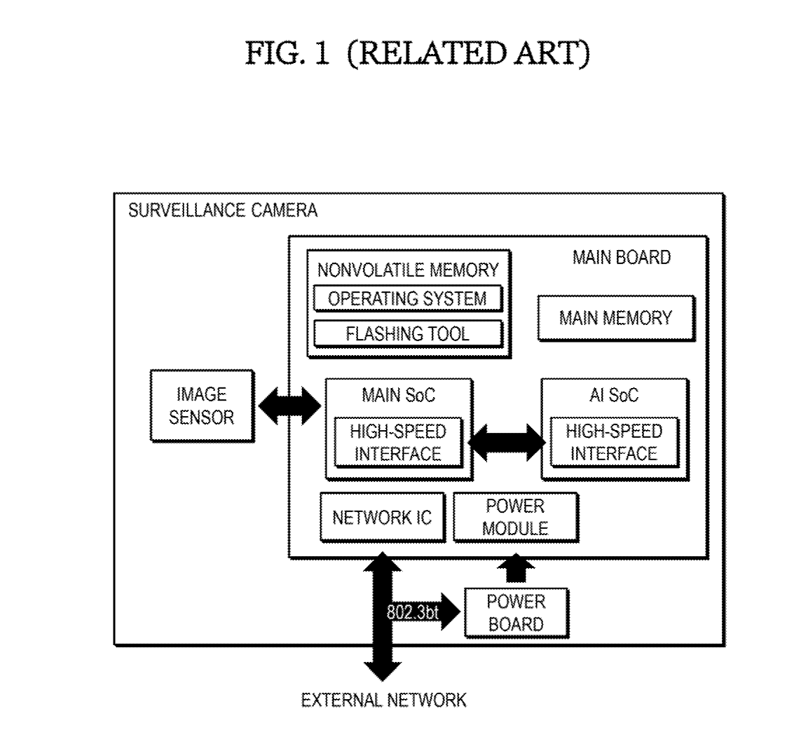

### DETAILED DESCRIPTION

Hereinafter, embodiments disclosed in this specification will be described in detail with reference to the accompanying drawings. The embodiments described herein are non-limiting example embodiments, and thus, the disclosure is not limited thereto and may be realized in various other forms. Each of the embodiments provided herein is not excluded from being associated with one or more features of another example or another embodiment also provided herein or not provided herein but consistent with the disclosure.

Identical or similar components will be assigned the same reference numbers, regardless of the drawing symbols, and redundant explanations will be omitted. The suffixes “module” and “unit” or “-er/or” used in this description are assigned or used interchangeably solely for the convenience of drafting the specification and do not themselves have distinct meanings or roles. Also, in describing the embodiments disclosed in this specification, detailed descriptions of well-known technologies may be omitted if it is determined that they could obscure the essence of the embodiments disclosed herein. Additionally, the accompanying drawings are provided merely to facilitate the understanding of the embodiments disclosed in this specification, and the technical spirit disclosed herein is not limited by the drawings. It should be understood that all modifications, equivalents, and substitutes that fall within the spirit and scope of this disclosure are included.

Terms including ordinal numbers, such as first, second, etc., may be used to describe various components, but the components are not limited by the terms. The above terms are used solely to distinguish one component from another.

When a component is referred to as being “connected” or “coupled” to another component, it should be understood that the component may be directly connected or coupled to the other component, or there may be intervening components in between. On the other hand, when a component is referred to as being “directly connected” or “directly coupled” to another component, it should be understood that there are no intervening components in between.

Singular expressions include plural expressions unless the context clearly indicates otherwise. As used herein, expressions “at least one of a, b, and c,” “at least one of a, b, or c,” and “a, b, and/or c” should be understood as including only a, only b, only c, both a and b, both a and c, both b and c, or all of a, b, and c.

Also, in embodiments, it may be understood that terms such as “including” or “having”, etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

Also, in embodiments, at least one of a plurality of components refers to all of the plurality of components, as well as each one excluding the rest of the plurality of components or any combination thereof. The expression “configured to” may be replaced by, for example, “suitable for”, “having the capacity to”, “designed to”, “adapted to”, “made to”, or “capable of”, according to situations. The expression “configured to” may not necessarily indicate “specifically designed to” in terms of hardware. Instead, in a certain situation, the expression “apparatus (device) configured to” may indicate that the apparatus (device) may be “capable of” performing an action together with another apparatus (device) or components. For example, “a processor configured to perform A, B, and C” may indicate a dedicated processor (e.g., an embedded processor) for performing corresponding operations or indicate a generic-purpose processor (e.g., a central processing unit (CPU) or an application processor) performing the corresponding operations by executing one or more software programs stored in a memory device.

In the disclosure, the term “image” encompasses a video, a still image, and a non-continuous video such as motion joint photographic experts group (MJPEG).

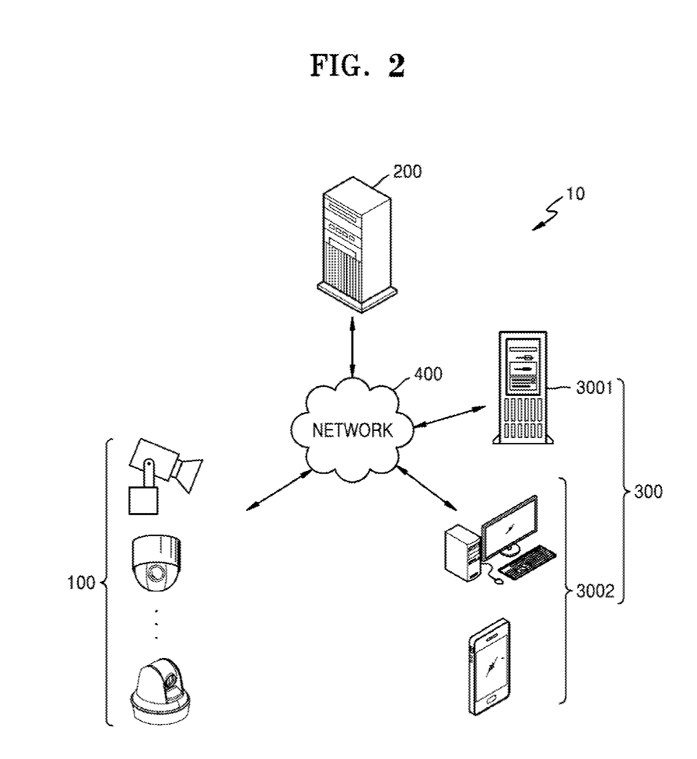

FIG. 2 is a diagram schematically showing a surveillance camera system 10 according to an embodiment.

Referring to FIG. 2, the surveillance camera system 10 according to an embodiment may include an image processing device 100 and an external device 300. According to an embodiment, the surveillance camera system 10 may further include a network server 200 capable of performing wired/wireless communication with the image processing device 100 and the external device 300.

The image processing device 100 may be a photographing electronic device configured to photograph a surveillance area to obtain an image and audio (sound) of the surveillance area. The image processing device 100 may photograph the surveillance area in real time for surveillance or security purposes, and one or more image processing devices 100 may be provided. The image processing device 100 may include a camera arranged at a fixed location of a specific place, a camera that may be automatically or manually moved along a certain path, or a camera that may be moved by a person or a robot. The image processing device 100 may be a pan-tilt-zoom (PTZ) camera having panning, tilting, and zooming functions. The image processing device 100 may be an analog camera or an Internet protocol (IP) camera or a network camera, which is used in connection to wired/wireless Internet. The image processing device 100 may have any shape and any size, such as a dome shape, a box shape, a bullet shape, or a camouflage type, depending on functions and purposes thereof.

According to an embodiment, the image processing device 100 may be a visible light camera that generates a visible image according to a luminance distribution of an object by obtaining image information through a method of detecting light. According to an embodiment, the image processing device 100 may be an infrared camera (or a thermal camera) that detects radiant energy (thermal energy) emitted from an object, detects the thermal energy in the form of an infrared wavelength that is a type of electromagnetic waves, and measures intensity of the thermal energy to generate a thermal image displaying different colors depending on the measured intensity.

The image processing device 100 may have a function of recording the surveillance area or capturing an image therefrom. The image processing device 100 may have a function of recording sound generated in the surveillance area. The image processing device 100 may have a function of, when a change, such as a movement or sound, occurs in the surveillance area, generating a notification about the change, or recording the change or capturing an image based on the change.

The image processing device 100 may analyze the captured image and/or an image obtained by editing the captured image. For example, the image processing device 100 may detect an object by using an object detection algorithm to detect an object from an image. The object detection algorithm may include an artificial intelligence (AI)-based algorithm, and an object may be detected by using a pre-trained artificial neural network model.

The image processing device 100 may analyze an image to generate metadata and index information about the metadata. The image processing device 100 may analyze an image and/or audio included in the image together or separately to generate metadata and index information about the metadata.

The network server 200 may provide various functions to the image processing device 100 and the external device 300 through a network 400. In FIG. 2, the network server 200 is shown as being provided independently from the image processing device 100, but an embodiment is not limited thereto. For example, the network server 200 may be embedded in the image processing device 100. The network server 200 will be described below.

The external device 300 may include a server 3001 and a client 3002.

The server 3001 may be an apparatus including a digital video recorder (DVR), a network video recorder (NVR), a video management system (VMS), or the like, and providing image storing, searching, and managing functions. The server 3001 may receive an image and/or audio from the image processing device 100 and store the same, and index the image and/or audio for a user’s search. The server 3001 may analyze the image and/or audio received from the image processing device 100. In an embodiment, a plurality of servers physically set at different locations may be federated with each other to be managed and controlled by one piece of software. In an embodiment, the server 3001 may be used in a government office, a police station, a hospital, a central control center, a master control station, an all-source situation room, or the like.

The client 3002 is a terminal including a mobile device such as a desktop personal computer (PC), a tablet PC, a slate PC, a notebook computer, or a smartphone, and may include software and/or an application for a user (operator) to perform image monitoring and searching. The client 3002 may be connected to the image processing device 100 and/or the server 3001 through the network 400. In an embodiment, the client 3002 may manage and operate the image processing device 100 and the server 3001 based on cloud.

According to an embodiment, the client 3002 may transmit, to the image processing device 100 or the server 3001, an information provision request signal requesting all or a portion of an image and/or audio, and receive, from the image processing device 100 or the server 3001, the all or the portion of the image and/or the audio. The client 3002 may transmit, to the image processing device 100 or the server 3001, an information provision request signal requesting metadata obtained by analyzing an image and/or audio, and/or index information about the metadata, and receive the metadata and/or the index information from the image processing device 100 or the server 3001.

The image processing device 100, the network server 200, and the external device 300 may perform wired/wireless communication through the network 400. The network 400 may include, for example, wired networks such as local area networks (LANs), wide area networks (WANs), metropolitan area networks (MANs), and integrated service digital networks (ISDNs), wireless Internet such as 3rd generation (3G), 4th generation (4G) (long-term evolution (LTE)), 5th generation (5G), wireless fidelity (Wi-Fi), wireless broadband (Wibro), world interoperability for microwave access (WiMAX), wireless LANs, and code division multiple access (CDMA), satellite communications, and wireless networks including short-range communications such as Bluetooth, radio frequency identification (RFID), infrared data association (IrDA), ultra-wideband (UWB), ZigBee, and near field communication (NFC). In wireless mobile communications, the network 400 may further include components such as a base station (BTS), a mobile switching center (MSC), a home location register (HLR), an access gateway that enables transmission and reception of wireless packet data, and a packet data serving node (PDSN). However, the present specification is not limited thereto.

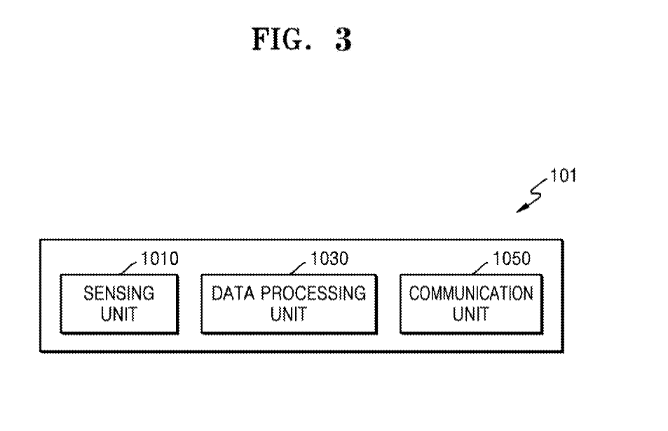

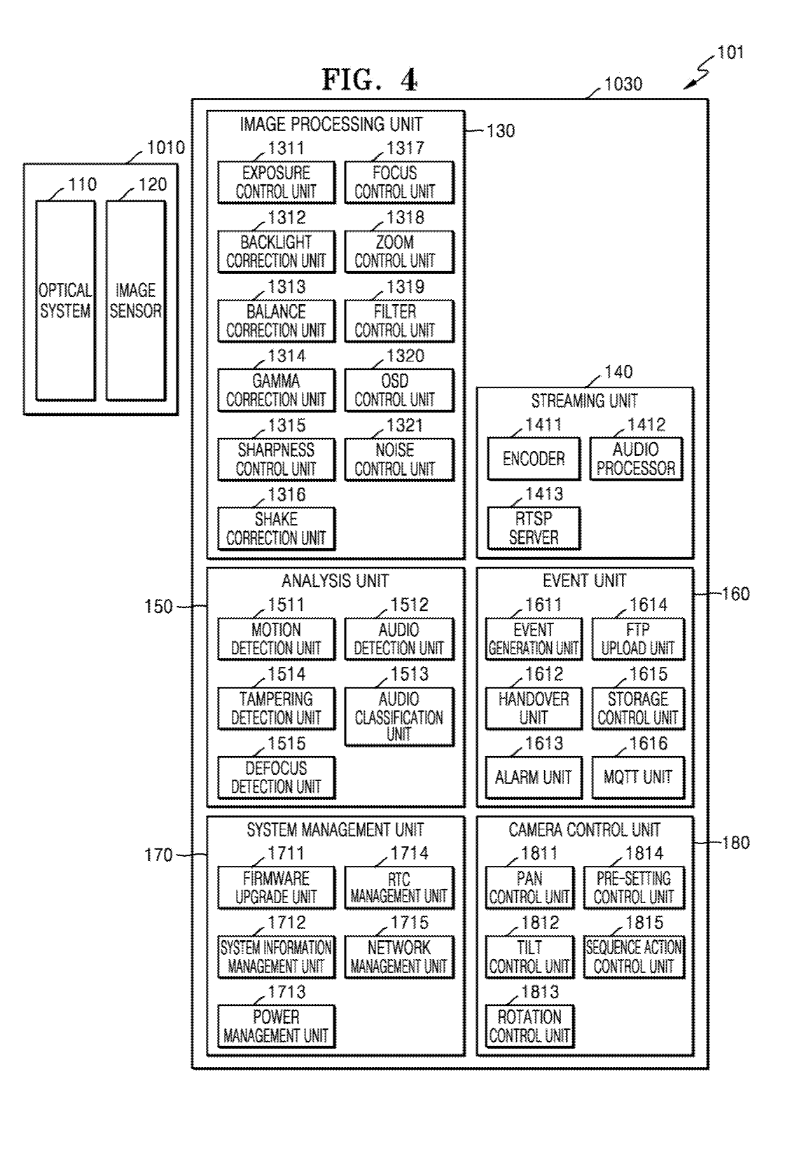

FIGS. 3 and 4 are schematic block diagrams of the image processing device 100 according to an embodiment.

According to an embodiment, the image processing device 100 may be a camera 101. The camera 101 may be an IP camera or a network camera. The camera 101 may obtain an image, compress the obtained image, and transmit the compressed image to the external device 300 (see FIG. 2) by using a certain transmission protocol. For example, the camera 101 may obtain an image, analyze the obtained image in real time to detect/identify/track/analyze behavior of/search for a target or moving object, and provide appropriate information or function to a user.

Referring to FIGS. 3 and 4, the camera 101 may include a sensing unit 1010, a data processing unit 1030, and a communication unit 1050.

The sensing unit 1010 may be a detecting unit including an optical system 110 and an image sensor 120.

The optical system 110 may optically process light received from a subject. The optical system 110 may include at least one lens such as a zoom lens controlling a field of view to be decreased or increased according to a focal length, and a focus lens adjusting a focus. According to an embodiment, the lens may include at least one glass lens and/or at least one liquid lens. The liquid lens is a lens capable of adjusting zoom and focus by controlling a thickness (a shape (curvature) of the liquid lens) by using liquid with fluidity. When the liquid lens is used, the number of lenses and a size of a lens module may be reduced, and a focal length may be quickly focused.

The optical system 110 may further include an optical low pass filter (OLPF), an infra-red cut filter (IRCF), and an iris for controlling the quantity of light.

The image sensor 120 may perform a function of obtaining an image by photographing a surveillance area. According to an embodiment, the image sensor 120 may be implemented as a charge-coupled device (CCD) sensor, a complementary metal-oxide semiconductor (CMOS) sensor, or the like. The image sensor 120 may convert an optical signal that passed through the optical system 110 into an electrical signal.

The data processing unit 1030 may be an information processing unit implemented by various numbers of hardware and/or software components that perform particular functions. For example, the data processing unit 1030 may be a data processing device embedded in hardware and may include a physically structured circuit to perform a function represented by code or command included in a program. Examples of the data processing device embedded in hardware may include processing devices such as a microprocessor, a central processing unit (CPU), an image signal processor (ISP), a processor core, a multiprocessor, an application-specific integrated circuit (ASIC), and a field programmable gate array (FPGA), but the disclosure is not limited thereto. The data processing unit 1030 may be implemented as a configuration (e.g., a single chip) in which at least two of the above-described processing units and processors are integrated, or implemented as configurations (e.g., a plurality of chips) of independent processing units and processors.

According to an embodiment, the data processing unit 1030 may further include a neural processing unit (NPU). According to an embodiment, the NPU may be included in the data processing unit 1030 by being embedded in the processing unit and processor. The NPU is a processor specialized in processing an AI model, and the AI model may be generated through machine learning. The AI model may include a plurality of artificial neural network layers. An artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination thereof, but is not limited thereto. The AI model may include, additionally or alternatively, a software structure, in addition to a hardware structure.

According to an embodiment, the AI model may be trained by collecting and labeling training data suitable for determining object detection/classification/recognition, and applying the training data to the artificial neural network. The trained AI model may be installed in the camera 101 and used for inference such as object detection/classification/recognition through the data processing device described above or the NPU of the camera 101.

According to an embodiment, the AI model may be additionally trained according to a monitoring environment or user requirements by using a cloud server even after being installed in the camera 101, and the newly trained model may be re-distributed and used in the camera 101.

The NPU may be installed in the camera 101 in the form of at least one hardware chip. For example, the NPU may be installed in the camera 101 by being manufactured in the form of an AI dedicated hardware chip or manufactured as a portion of a general-purpose processor (CPU) or a graphics dedicated processor (GPU). Also, the NPU may be implemented as a software module. When the NPU is implemented as the software module (or a program module including instructions), the software module may be stored in a non-transitory computer-readable medium. In this case, at least one software module may be provided by an operating system (OS) or an application. The data processing unit 1030 may include an image processing unit 130, a streaming unit 140, an analysis unit 150, an event unit 160, a system management unit 170, and a camera control unit 180.

The image processing unit 130 may improve image quality by adjusting luminance, contrast, a color amount, a contrast ratio, sharpness, and the like of an image. A value of each parameter for image quality improvement may be fixed to an initial value or may be adjusted and pre-set by a user. The image processing unit 130 may perform image signal processing for improving image quality, such as noise reduction, gamma correction, color filter array interpolation, color matrix, color correction, and color enhancement. The image processing unit 130 may apply various methods to improve image quality, such as an edge enhancement algorithm, a histogram-based image quality improvement algorithm such as histogram equalization or histogram stretching, and a color control (HUE Control) algorithm. According to an embodiment, the image processing unit 130 may be an image signal processor (ISP). The image processing unit 130 may include an exposure control unit 1311, a backlight correction unit 1312, a balance correction unit 1313, a gamma correction unit 1314, a sharpness control unit 1315, a shake correction unit 1316, a focus control unit 1317, a zoom control unit 1318, a filter control unit 1319, an on-screen display (OSD) control unit 1320, and a noise control unit 1321.

The exposure control unit 1311 may control brightness of an image by adjusting a quantity of light entering the image sensor 120 by using at least one of a shutter, an iris, and a gain or International Organization for Standardization (ISO) sensitivity. The exposure control unit 1311 may adjust the quantity of light by adjusting a shutter speed. The exposure control unit 1311 may adjust the quantity of light by adjusting an opening/closing degree of the iris. The exposure control unit 1311 may control an amplification level of light by adjusting the gain or ISO sensitivity. According to an embodiment, the exposure control unit 1311 may adjust the shutter, the iris, and the gain/ISO sensitivity according to user settings. According to an embodiment, the exposure control unit 1311 may perform an auto exposure algorithm according to illumination of an environment in which the camera 101 is installed, when a corresponding function is set.

The backlight correction unit 1312 may improve quality of an image by applying a backlight correction algorithm to the image such that a dark region is clearly visible when the image is too bright overall. The backlight correction algorithm may include a backlight compensation (BLC) algorithm, a wide dynamic range (WDR) algorithm, a digital-WDR (D-WDR) algorithm, and a high dynamic range (HDR) algorithm. The backlight correction unit 1312 may increase a dynamic range by using the WDR algorithm, the D-WDR algorithm, and the HDR algorithm such that a bright region and a dark region of the image a simultaneously clearly visible. According to an embodiment, the backlight correction unit 1312 may block backlight of a specific region such that other regions of an image are brighter. For example, when headlights of a vehicle shine strongly at an entrance of a dark parking lot or at an entrance of a gas station at night, only light of the headlights may be blocked to identify a license plate of the vehicle. Whether to perform a function (on/off) of the backlight correction unit 1312 may be set by a user.

The balance correction unit 1313 may compensate for a difference in colors according to a light source (lighting) by adjusting white balance of an image to increase color discrimination of the image. According to an embodiment, the balance correction unit 1313 may adjust white balance appropriately to a light source selected according to user settings. According to an embodiment, when a corresponding function is set, the balance correction unit 1313 may perform an auto white balance algorithm according to an environment around the camera 101. According to an embodiment, the balance correction unit 1313 may adjust white balance of an image by using a white balance value manually set by the user.

The gamma correction unit 1314 may increase visibility by changing contrast of an image through gamma correction.

The sharpness control unit 1315 may increase resolution by adjusting sharpness of a boundary (outline) of a subject.

The shake correction unit 1316 may stabilize an image by compensating for image shaking occurred by shaking of the camera 101 by applying a shake correction algorithm to an image. The shake correction algorithm may include an optical image stabilization (OIS) algorithm, an electronic image stabilization (EIS) algorithm, and a digital image stabilization (DIS) algorithm.

The focus control unit 1317 may adjust a focus of the camera 101 by using a focus control algorithm. According to an embodiment, the focus control unit 1317 may move a location of a focus lens by controlling a focus motor according to a control signal for focus control. The focus control algorithm may include a well-known auto focus algorithm such as a hill climbing method. For example, the focus control unit 1317 may move a location of the focus lens between a close distance and a long distance (infinity) in real time, compare focus values before and after, and identify an increase or decrease in the focus values, an inclination, a change in the inclination, and the like to determine a peak point with the largest focus value as a best focus location and control an operation of the focus motor to move the focus lens to the best focus (in-focus) location. According to an embodiment, the focus control unit 1317 may control a focus by controlling a curvature of a liquid lens according to a control signal for focus control.

The zoom control unit 1318 may perform an optical zoom and/or digital zoom function according to a control signal for zoom magnification control. According to an embodiment, the zoom control unit 1318 may adjust a magnification by adjusting a zoom magnification by moving a location of a zoom lens to zoom-in or zoom-out the zoom lens. According to an embodiment, the zoom control unit 1318 may control the zoom magnification by controlling the curvature of the liquid lens. According to an embodiment, the zoom control unit 1318 may provide a further enlarged image by using digital zoom exceeding optical zoom. An angle of view or a field of view of the camera 101may be controlled by the zoom magnification.

The filter control unit 1319 may improve image discrimination during the day and night by adjusting an infra-red cut filter (IRCF). The filter control unit 1319 may locate the IRCF in front of the image sensor 120 to block infrared rays and transmit visible rays. The filter control unit 1319 may remove the IRCF to transmit infrared rays in addition to visible rays. The filter control unit 1319 may perform a day/night mode function by automatically turning the IRCF on/off according to ambient illumination.

The OSD control unit 1320 may overlay text and/or a polygonal mask on an image. For example, the OSD control unit 1320 may display, at a certain location of an image, a date, a time, a manufacturer, or the like.

The noise control unit 1321 may perform a digital noise reduction algorithm to reduce color noise in an image captured in a low luminance environment. The noise reduction algorithm may include 2-dimensional (2D)-noise reduction (NR) and 3-dimensional (3D)-NR.

The streaming unit 140 may compress an image received from the image processing unit 130 and provide the compressed image to an external device through a network. The streaming unit 140 may include an encoder 1411, an audio processor 1412, and a real-time streaming protocol (RTSP) server 1413.

The encoder 1411 may compress an image by encoding the image. The encoder 1411 may compress a raw image input from the image sensor 120 or an image processed by the image processing unit 130. According to an embodiment, the raw image may be used for an AI algorithm or the like.

The encoder 1411 may compress an image by using an intra-frame compression method and/or an inter-frame compression method. The encoder 1411 may compress an image in a compression format of H.264, H.265 (high efficiency video coding (HEVC)), Joint Photographic Experts Group (JPEG), Moving Picture Experts Group (MPEG)-4, or the like, depending on a network environment or a monitoring purpose.

The encoder 1411 may generate at least one image stream by compressing the image according to encoding settings. The encoding settings may include a compression format, image quality (high quality/medium quality/low quality), resolution, a bit rate, a framerate, and the like. The encoder 1411 may compress an image by using a constant bitrate (CBR) or a variable bitrate (VBR). A profile of an image stream may be determined according to the encoding settings. The profile may indicate a specification of a bitstream transmitted from the camera 101 to the external device. The profile may include setting values for a compression format, image quality (high quality/medium quality/low quality), resolution, a frame rate, a bit rate, and the like. For example, the profile may include setting values of “MJPEG, low quality, 640×840, 5 fps, 2 Mbps”. According to an embodiment, the profile of the image stream output from the encoder 1411 may be pre-set according to a network environment and an image receiving device (external device). For example, profiles suitable for streaming purposes may be pre-set, such as a profile of an image stream for storage, a profile of an image stream for a monitoring screen output, a profile of an image stream for a mobile device, and a profile of an image stream for a web viewer. The encoder 1411 may compress an image to setting values of a selected profile.

The audio processor 1412 may include an audio codec and generate at least one audio stream by processing and compressing audio input from an audio sensor and/or a stored sound source. The audio sensor may include a dynamic microphone, a condenser microphone, a ribbon microphone, or the like depending on a microphone structure, and may include a directional microphone, an omnidirectional microphone, a super-directional microphone, or the like depending on directivity. The audio sensor may be provided separately from the image sensor 120 or integrated with the image sensor 120, e.g., embedded in the image sensor 120.

The RTSP server 1413 may be a server operated for real-time image streaming. The RTSP server 1413 may transmit an image stream and an audio stream to an external device connected to an RTSP port through a network, according to RTSP.

The analysis unit 150 may analyze, in real time, an image processed by the image processing unit 130. The analysis unit 150 may perform background detection, foreground and object detection, object counting, camera tampering detection, and face detection. Also, the analysis unit 150 may calculate information about brightness, a color, texture, and shape of an image. The analysis unit 150 may analyze, in real time, audio input from the audio sensor. Results of analyzing image and/or audio may be generated as metadata. According to an embodiment, the analysis unit 150 may detect/recognize/identify an object by using AI-based technology.

The analysis unit 150 may include a motion detection unit 1511, an audio detection unit 1512, an audio classification unit 1513, a tampering detection unit 1514, and a defocus detection unit 1515.

The motion detection unit 1511 may detect a motion of an object in an image. The motion detection unit 1511 may detect a motion of an object from an image by using a motion detection (MD) algorithm. According to an embodiment, the motion detection unit 1511 may detect a motion by using an artificial neural network (ANN).

The audio detection unit 1512 may detect an audio input from the audio sensor.

The audio classification unit 1513 may classify the detected audio input. According to an embodiment, the detected audio input may be classified into a vocal input that is sound produced from a person’s throat and a non-vocal input that is other sound. For example, the vocal input may be classified into conversation, scream, crying, and the like, and the non-vocal input may be classified into footsteps, glass breaking, an explosion, a crash, a gunshot, and the like. Types of the vocal input and the non-vocal input are not limited thereto and may be variously set according to a surveillance area and a system design. According to an embodiment, the audio classification unit 1513 may learn audio features by using ANN and classify audio.

The tampering detection unit 1514 may detect a camera movement or camera obstruction that continues for a certain period of time. For example, the tampering detection unit 1514 may detect a situation in which a lens has been sprayed, a situation in which a lens is covered, and the like.

The defocus detection unit 1515 may detect a focus misalignment.

The event unit 160 may receive an image and/or audio from the analysis unit 150. The event unit 160 may receive, from the analysis unit 150, metadata indicating results of analyzing an image and/or audio. The event unit 160 may detect an event based on the metadata and notify event detection. The event unit 160 may generate an event rule such that a device performs an action when a specific event occurs. The event rule may include a condition and an action. The condition may be a detailed rule for detecting an event. The action may be an operation performed when occurrence of an event is determined. The event unit 160 may associate an action to be performed in response to occurrence of an event. According to an embodiment, a condition of an event and an action associated with the event may be pre-defined by the user.

The event unit 160 may include an event generation unit 1611, a handover unit 1612, an alarm unit 1613, a file transfer protocol (FTP) upload unit 1614, a storage control unit 1615, and a message queuing telemetry transport (MQTT) unit 1616.

The event generation unit 1611 may generate a condition by using a combination of several situations detected as results of analyzing an image and/or audio. The event generation unit 1611 may detect an event by using a condition set according to an event type.

According to an embodiment, the event generation unit 1611 may generate an image event when a result of analyzing an image satisfies an event condition. The image event may include appearance (entrance) and/or disappearance of an object in a screen, occurrence of an image (e.g., a face that is not recognizable) specified by the user, a change in a screen color, detection of motion of an object, detection of motion within an area specified by the user, detection of motion in a direction specified by the user, image being turned off, tampering, and focus misalignment.

According to an embodiment, the event generation unit 1611 may generate an audio event when a result of analyzing audio satisfies an event generation condition. The audio event may include user-defined events, such as generation of an audio signal specified by the user, such as conversation, scream, crying, or shouting, generation of an abnormal audio signal, such as footsteps, an alarm, a crash, a skid, glass breaking, an explosion, or a gunshot, and generation of vocal exceeding a threshold value.

According to an embodiment, the event generation unit 1611 may generate an event when a combination of an image analysis result and/or an audio analysis result satisfies an event generation condition. Types of the image event and the audio event are not limited thereto and may be variously set according to a surveillance area and a system design.

The handover unit 1612 may transmit a generated event or event generation conditions to another camera or receive an event or an event generation condition from another camera to cause the camera 101 to perform a set operation when an event is generated, such as panning, tilting, zooming, or automatic object tracking.

The alarm unit 1613 may output an alarm signal when an event is generated. The alarm unit 1613 may trigger an input of various sensors outside the camera 101 or an output to an actuator so as to output the alarm signal. The alarm unit 1613 may notify event generation through audio reproduction, email transmission, or the like.

The FTP upload unit 1614 may upload image and/or audio, in which an event has been detected, to an FTP server on a network when an event is generated. The image may include a still image and a moving image. According to an embodiment, the FTP upload unit 1614 may upload, to the FTP server, the image and/or the audio, in which the event has been detected, at a set upload speed during a set upload period, when the event is generated.

The storage control unit 1615 may store (record) image and/or audio in a storage device. According to an embodiment, the storage control unit 1615 may store, in the storage device, image and/or audio and metadata received from the analysis unit 150. The metadata may include object information (e.g., movement, sound, or intrusion into a designated area) detected from image and/or audio, object identification information (e.g., a person, a vehicle, a license plate, a face, a hat, or clothing), and detected location information (e.g., coordinates or size). According to an embodiment, when an event is generated, the storage control unit 1615 may store, in the storage device, an image and/or audio and metadata of a certain period of time before and after the event generation. The storage control unit 1615 may store an image according to a set profile.

The storage device may store various programs and data required for operations of the camera 101. The storage device may perform reading/writing/revising/deleting/updating of data by using each component including the image processing unit 130. The storage device may store a neural network model (e.g., a deep learning model) generated through a learning algorithm for data recognition/classification. The storage device may include an internal memory and/or an external storage medium such as a secure digital (SD) card. The storage device may include a VMS and a network video recorder (NVR). The storage device may include a storage area network (SAN) and a network-attached storage (NAS) such as a web storage or a cloud server, which perform a storage function on the Internet.

The MQTT unit 1616 may transfer an event (notify an event) or may be notified of event generation by using an MQTT protocol. According to an embodiment, the MQTT unit 1616 may include an MQTT client and transfer an event to an MQTT broker (server) in real time by using the MQTT protocol through the MQTT client by posing an MQTT message. According to an embodiment, the MQTT unit 1616 may be notified of event generation in real time by subscribing to the MQTT message posted in the MQTT broker (server) and start image recording.

The system management unit 170 may include a firmware (F/W) upgrade unit 1711, a system information management unit 1712, a power management unit 1713, a real-time communication (RTC) management unit 1714, and a network management unit 1715.

The F/W upgrade unit 1711 may upgrade F/W of the camera 101. The F/W upgrade unit 1711 may receive new F/W from a F/W server via wires or wirelessly and upgrade F/W of an old version.

The system information management unit 1712 may manage information about a product, such as a model name, a serial number, and the like of the camera 101.

The power management unit 1713 may convert alternating current (AC) or direct current (DC) power received from an external power source into power required for an operation of each component of the camera 101 and supply the same. The power management unit 1713 may include an auxiliary power source such as a chargeable embedded battery or a replaceable battery. The power management unit 1713 may manage power according to a level of an Ethernet power device (PoE). The power management unit 1713 may manage and control the auxiliary power source and the external power source in a maximum power mode and a low power mode.

The RTC management unit 1714 may manage an internal time of the camera 101 in synchronization with a network server such as network time protocol (NTP).

The network management unit 1715 may manage general network functions, such as an IP address setting, a port setting, and a dynamic domain name server (DDNS) setting.

The camera control unit 180 may control a posture of the camera 101 by moving the camera 101 to a physical location corresponding to a pan/tilt/rotate/zoom focus value according to object motion information, a user input, or a pre-setting. The camera control unit 180 may include a pan control unit 1811, a tilt control unit 1812, a rotation control unit 1813, a pre-setting control unit 1814, and a sequence action control unit 1815.

The pan control unit 1811 may control rotation of the camera 101 in a horizontal direction. According to an embodiment, the pan control unit 1811 may control driving of a pan motor based on a pan value to rotate the camera 101 in the horizontal direction.

The tilt control unit 1812 may control rotation of the camera 101 in a vertical direction. According to an embodiment, the tilt control unit 1812 may control driving of a tilt motor based on a tilt value to rotate the camera 101 in the vertical direction.

The rotation control unit 1813 may control rotation of the camera 101 in a clockwise direction or a counterclockwise direction of an image. The rotation control unit 1813 may rotate a lens in the clockwise direction or the counterclockwise direction of the image based on a center of the camera 101.

The pre-setting control unit 1814 may quickly move the camera 101 to a physical location corresponding to a pre-designated pan/tilt/rotate/zoom focus value (pre-setting). The pre-setting control unit 1814 may change a posture of the camera 101 while moving or rotating the camera 101 according to at least one designated pre-setting.

The sequence action control unit 1815 may repeatedly control an operation of the camera (01 by scheduling an operation pre-designed by the pre-setting or the like.

The communication unit 1050 may be an interface configured to transmit a stream by communicably accessing the network server 200 and the external device 300 via wires or wirelessly. The communication unit 1050 may include a TCP/IP, HTTP(S)/RTP/RTSP, FTP, MQTT protocols.

To avoid obscuring features of the present embodiment, only components relevant to the present embodiment are shown. Accordingly, it would be obvious to one of ordinary skill in the art that general-purpose components other than the components shown in FIGS. 3 and 4 may be further included.

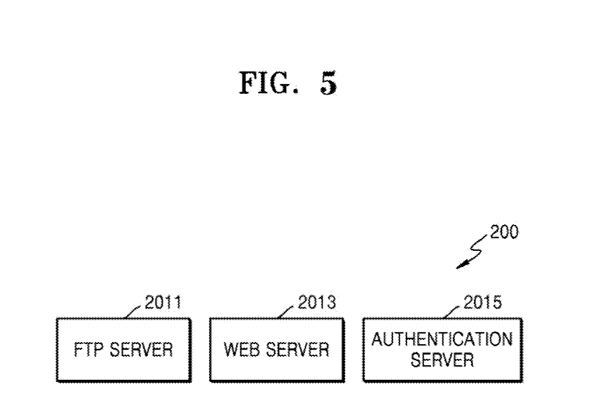

FIG. 5 is a schematic block diagram of the network server 200 according to an embodiment.

Referring to FIG. 5, the network server 200 according to an embodiment may include an FTP server 2011, a web server 2013, and an authentication server 2015. The network server 200 may be independently provided on the network 400 separately from a camera or may be embedded in the camera.

The FTP server 2011 may receive, from the FTP upload unit 1614 of the image processing device 100, an image and/or audio in which an event has been detected when the event is generated.

The web server 2013 may provide an HTTP(S) access to the image processing device 100 and the external device 300 or may be embedded in the image processing device 100 or the server 3001 to provide an HTTP(S) access to the external device 300.

The authentication server 2015 may perform user authentication during an attempt of accessing the image processing device 100 of the external device 300 using RTP/RTSP/HTTP/TCP.

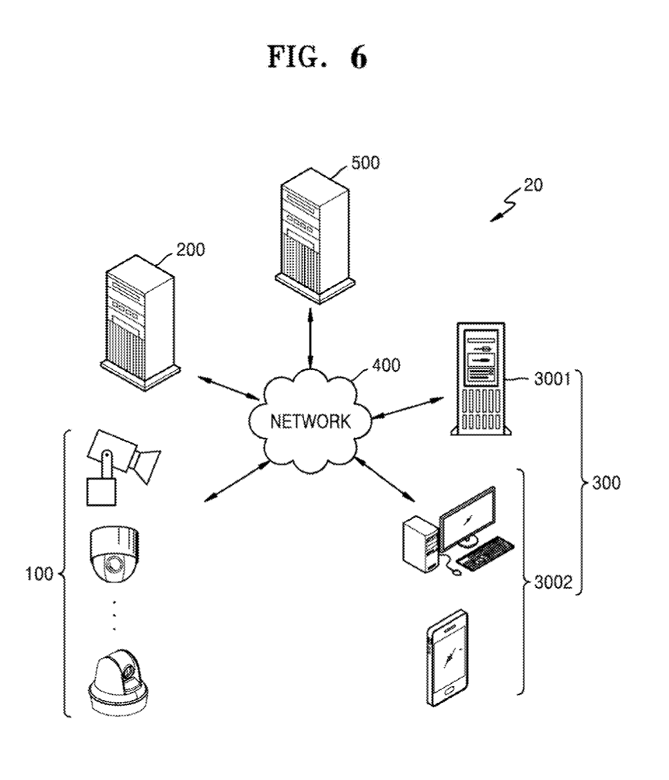

FIG. 6 is a diagram schematically showing a surveillance camera system 20 according to an embodiment.

Referring to FIG. 6, the surveillance camera system 20 according to an embodiment may include the image processing device 100, the network server 200, the external device 300, and an image analysis server 500. Hereinafter, only differences from the surveillance camera system 10 of FIG. 2 will be mainly described.

The image analysis server 500 may be a device that receives and stores an image captured through the image processing device 100 or an image obtained by editing the image. The image analysis server 500 may perform an image and/or audio analysis function of the image processing device 100 of FIG. 2. For example, the image analysis server 500 may analyze an image received from the image processing device 100 in real time and/or a stored image according to purposes. The image analysis server 500 may analyze an image to generate metadata and index information about the metadata. The image analysis server 500 may analyze an image and/or audio included in the image together or separately to generate metadata and index information about the metadata. The image analysis server 500 may be an AI server implementing an AI image analysis function.

The external device 300 may transmit, to the image analysis server 500, an information provision request signal requesting provision of all or a portion of an image and/or audio. The external device 300 may transmit, to the image analysis server 500, an information provision request signal requesting metadata obtained by analyzing an image and/or audio and/or index information about the metadata.

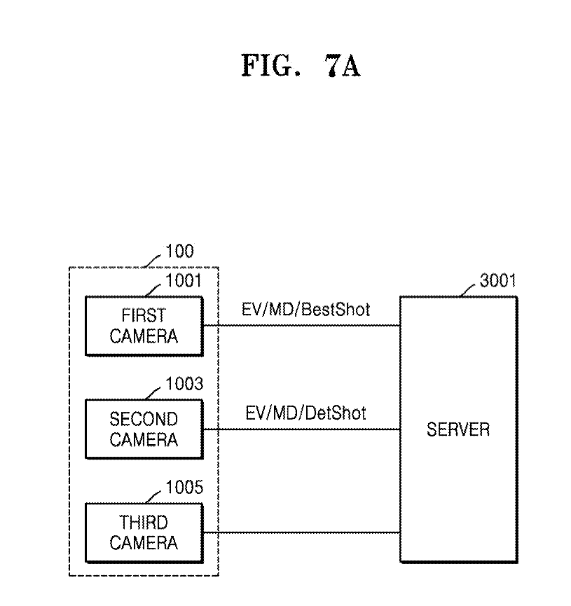

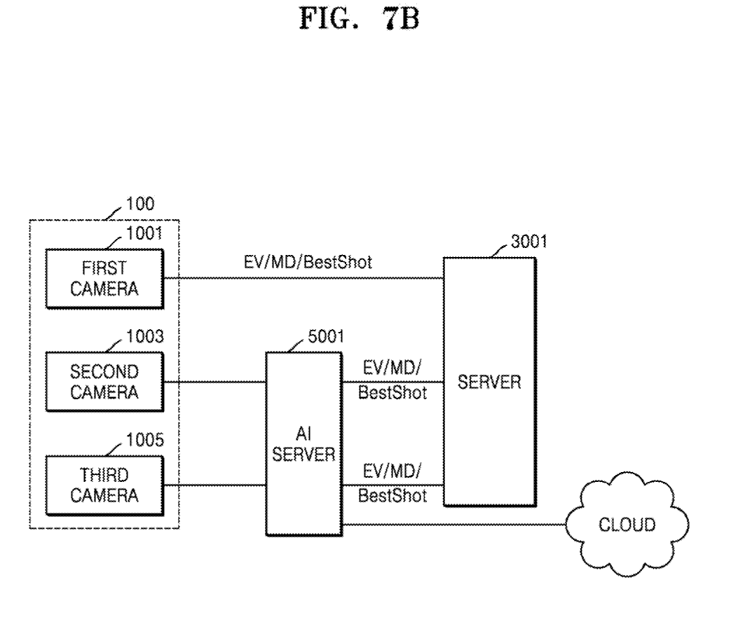

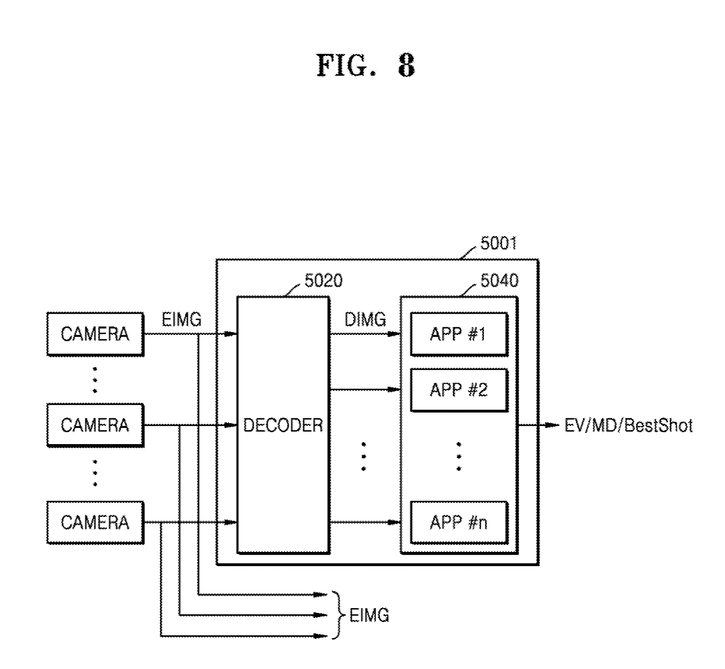

FIGS. 7A and 7B are diagrams schematically showing a surveillance camera system according to an embodiment. FIG. 8 is a diagram schematically showing an AI server 5001 according to an embodiment.

Referring to FIG. 7A, a plurality of the image processing devices 100 may include heterogeneous cameras with different functions. For example, a plurality of cameras may include at least one IP camera and at least one analog camera, and the at least one IP camera may include an AI camera including NPU. Hereinafter, for convenience of description, the AI camera will be referred to as a first camera 1001, the IP camera without an AI function will be referred to as a second camera 1003, and the analog camera will be referred to as a third camera 1005.

A function may be added to the first camera 1001 and the second camera 1003 as the first camera 1001 and the second camera 1003 may each include at least one third party application of a specific function installed through an open platform. The first camera 1001 and the second camera 1003 may analyze an image to detect/track/classify an object in real time, and provide a notification function in real time when a set event occurs. The first camera 1001 may analyze an image in a deep learning manner by using AI and generate attribute information of the image.

The server 3001 may monitor and manage the plurality of image processing devices 100. The server 3001 may monitor an image obtained by the image processing device 100 in response to an information provision request from the client 3002, and search for a stored image. According to an embodiment, the server 3001 may be a VMS.

The server 3001 may be notified of an event EV when an event occurs and receive an image and/or metadata MD from the first camera 1001 and the second camera 1003. The image may be a raw image and a detected image DetShotor an optimal image BestShot. The server 3001 may search for an object and an attribute, based on the optimal image BestShot received from the first camera 1001. The server 3001 may search for an object, based on the detected image DetShot received from the second camera 1003. The optimal image BestShot may be an image selected from at least one detected image DetShot or an object image that is a portion of the selected image.

The server 3001 may receive an image from the third camera 1005. The server 3001 may analyze the image received from the third camera 1005. The third camera 1005 may not perform an image analysis function.

Referring to FIG. 7B, the surveillance camera system may further include the AI server 5001 connected to the second camera 1003) and the third camera 1005. The AI server 5001 may receive an image from the second camera 1003 and the third camera 1005, and provide an image analysis result of a same or similar level as the first camera 1001 by using an AI image analysis technology. The AI server 5001 may be connected to a cloud server.

As shown in FIG. 8, the AI server 5001 may include a decoder 5020 and at least one third party application 5040. The AI server 5001 may decode, by using the decoder 5020, an encoded image EIMG received from at least one camera and analyze a decoded image DIMG through the application 5040 using an AI model. The at least one application 5040 may include a behavior analysis application, a fire/smoke detection application, and the like.

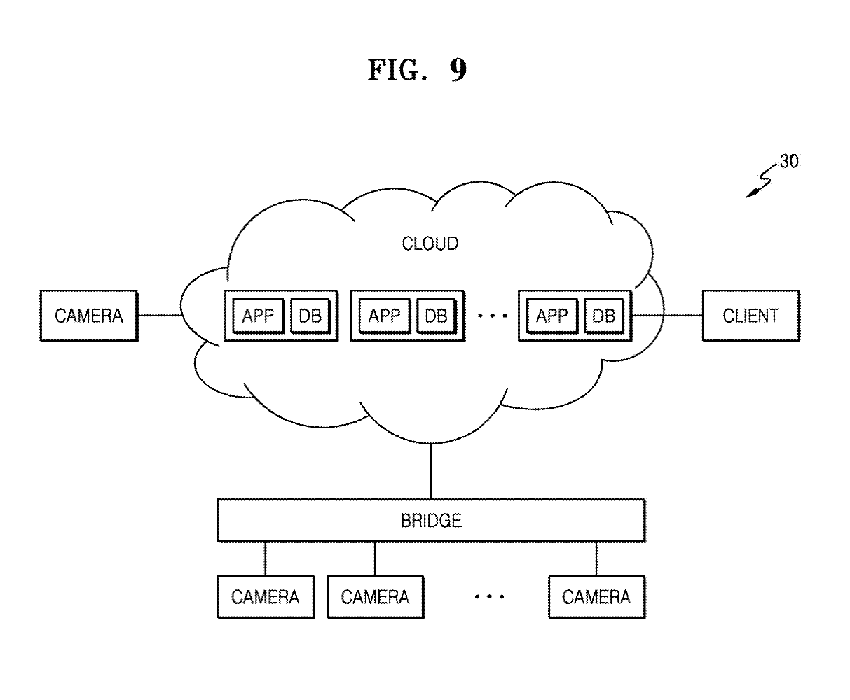

FIG. 9 is a diagram schematically showing a cloud-based surveillance camera system 30 according to an embodiment.

Referring to FIG. 9, in the cloud-based surveillance camera system 30, a camera and a client may transmit/receive data through a cloud. The cloud may include at least one cloud server including an application APP and a database DB. According to an embodiment, the camera may include a cloud application to be directly connected to the cloud via wires or wirelessly or may be connected to the cloud via wires or wirelessly through a bridge device such as a gateway. The client may access the cloud via wires or wirelessly to monitor a stored image or to be notified, from the cloud, of an event according to an image analysis.

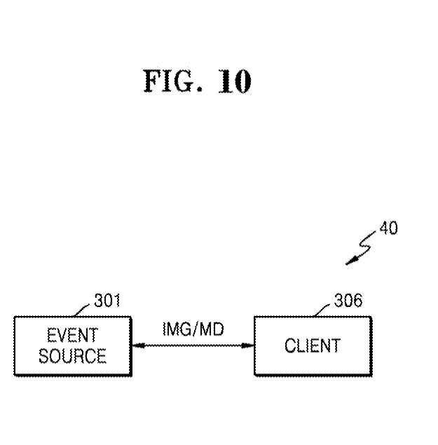

FIG. 10 is a diagram schematically showing a surveillance system 40 according to an embodiment.

Referring to FIG. 10, the surveillance system 40 according to an embodiment may include an event source 301 and a client 306.

The event source 301 may be installed in a certain area, include a detecting unit, an information processing unit, and a communication unit, and detect an event at the installed area. According to an embodiment, the event source 301 may be a surveillance camera, such as a visual camera, a thermal image camera, or a special-purpose camera, including an image sensor as the detecting unit. The event source 301 may further include, in addition to the image sensor, a motion sensor, an audio sensor, an olfactory sensor, a temperature sensor, a humidity sensor, an access control system, or a terminal, as the detecting unit.

The event source 301 may include a storage device for inputting/outputting information, such as a hard disk drive, a solid state drive (SSD), a flash memory, a compact flash (CF) card, an SD card, a smart media (SM) card, a multi-media card (MMC), or a memory stick. The event source 301 may further include a storage device such as a digital video recorder (DVR), a network video recorder (NVR), or a VMS. The storage device may receive detection data from the detecting unit and store the same. For example, the detection data may include image data, motion data, audio data, temperature data, and access request data.

The information processing unit may be implemented by various numbers of hardware and/or software configurations that perform particular functions. According to an embodiment, the information processing unit may generate the metadata MD based on the detection data and generate an event based on the metadata MD. For example, the information processing unit may recognize an object by analyzing an image, extract the metadata MD about the object, and store the metadata MD in combination with an event image including the object. The information processing unit may use a deep learning image analysis algorithm or the like to perform image analysis, object recognition and extraction, object classification and attribute determination, and metadata extraction. The metadata MD may include text-based metadata and an image-based metadata such as a background model or a blob image of a movement area. The text-based metadata may be realized in various formats interpretable by a system. For example, the metadata MD may be realized in a text format having a rule, such as XML or JSON, or in a binary format defined by its own protocol.

The metadata MD may include information extracted from the detection data. For example, when the detection data is image data, metadata MD may include image identification information, appearance/disappearance of an object (a person, a vehicle, or the like), an attribute of an object (e.g., object information such as a type, a color, a size, a location, a shape, movement, and a trajectory), situation information of an object (e.g., getting on and off a vehicle), occurrence of a specific image (e.g., appearance of a specific target), and face detection. When the detection data is audio data, the metadata MD may include information such as occurrence of an abnormal sound source (e.g., car tire screeching (skid), glass breaking, alarm, crash, yelling, screaming, or crying) and occurrence of sound of a threshold value or more.

The event source 301 may be registered in at least one client 306, receive an information provision request from the registered client 306, and provide, to the client 306, an image and/or audio corresponding to the information provision request, based on the metadata MD. The event source 301 may provide, to the client 306, the metadata MD together with an image IMG and/or audio. For example, the event source 301 may notify the client 306 of an event when the event occurs according to a set event rule, and transmit event information.

The client 306 may be registered with at least one event source 301. The client 306 may receive the event information from the at least one registered event source 301.

The above-described surveillance system is provided merely to describe an example operating environment in which the disclosure may be applied. As described below, the inventive concept of the disclosure lies in a structure and a method in which a main board and a connector board may be separately provided within a surveillance camera, and power supplied to, and/or an operation mode of, a modular computing device mounted in an interface may be selectively controlled, thereby allowing a firmware update, a reboot, and/or a selective upgrade of the modular computing device while maintaining the operation of the main board.

In an embodiment, a surveillance camera according to the disclosure may include a main board (or a first circuit board) on which a main System on Chip (SoC) (or a first computing device) for video processing is mounted, and a connector board (or a second circuit board) including an interface to which a modular AI computing device (or a second computing device) is removably coupled. The connector board may include a power control logic (or power supply control circuit) configured to selectively interrupt or provide power supplied to the modular computing device mounted on the interface, and a mode setting logic (or operation mode setting circuit) configured to set an operation mode of the modular computing device. Accordingly, a firmware update and a reboot of the modular computing device may be performed without interrupting power to the entire surveillance camera.

In an embodiment, the main board and the connector board may be connected through a communication interface capable of high-speed data transmission, and the communication interface may include, for example but not limited to, universal serial bus (USB), peripheral component interconnect express (PCIe), Ethernet, inter-integrated circuit (I²C), serial peripheral interface (SPI), or any combination thereof. In addition, one or more digital control signal paths for setting the operation mode of the modular computing device and controlling power supplied thereto may be further provided between the main board and the connector board.

In an embodiment, the modular computing device may be mounted in a socket conforming to a standard interface specification such as, for example but not limited to, small outline dual in-line memory module (SO-DIMM), M.2, or mobile PCI express module (MXM). However, the disclosure is not limited thereto, and other forms of removable interfaces or socket structures may be applied.

In addition, in an embodiment, a firmware image and/or a flashing tool for updating firmware of the modular computing device may be stored in a storage device or memory of the main board. Accordingly, the main board may perform a firmware update for the modular computing device mounted on the interface even during operation of the surveillance camera. In this case, since the main board may continuously acquire, process, store, and/or transmit video data even while replacement of the modular computing device is being performed, loss or omission of surveillance recording may be reduced.

The above-described video processing apparatus, network server, external device, video analysis server, and cloud-based configuration are intended to describe an example environment of the surveillance camera system, and the inventive concept of the disclosure lies in a structure and method for performing a firmware update and/or a reboot of the modular computing device while maintaining the operation of the main board, through cooperation among the main board, the connector board, the modular computing device mounted on the interface, the power control logic, and/or the mode setting logic, as will be described below.

That is, an embodiment of the disclosure is characterized in that, while maintaining operation of the main board, which performs basic video acquisition and processing functions of the surveillance camera, the connector board may selectively control only the power supplied to the modular computing device mounted on the interface and the operation mode thereof, thereby enabling a firmware update, a reboot, and/or a selective replacement of the modular computing device without stopping the entire surveillance camera.

Hereinafter, embodiments of the disclosure will be described in detail with reference to the accompanying drawings.

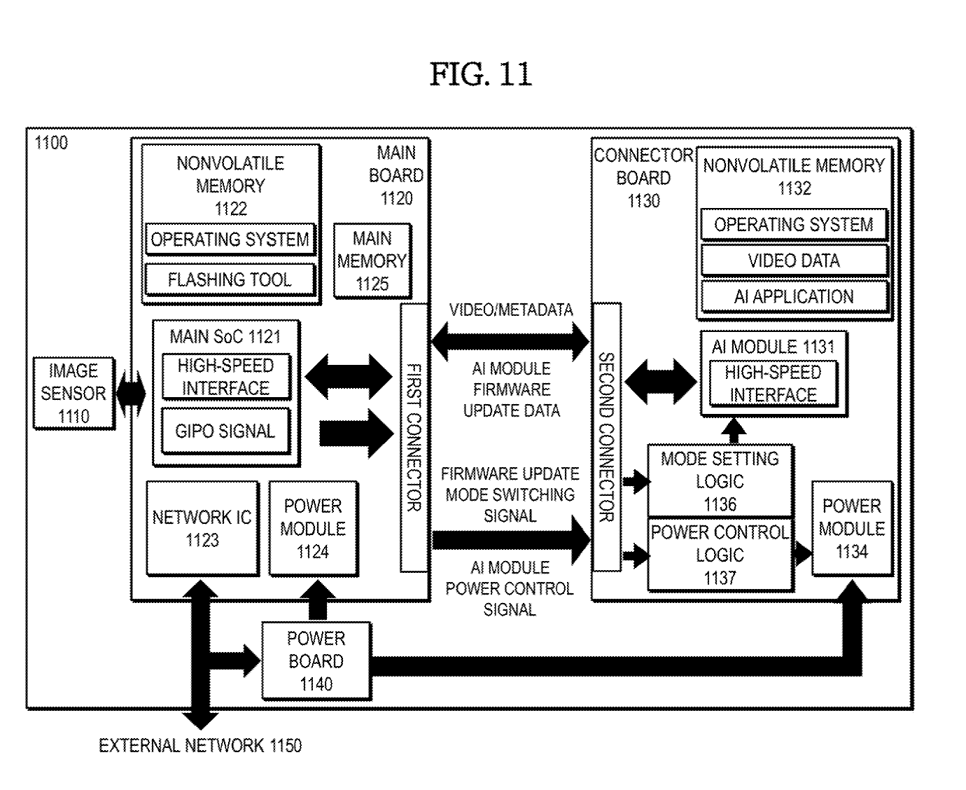

FIG. 11 is a schematic block diagram of a surveillance camera according to an embodiment.

Referring to FIG. 11, a surveillance camera 1100 may include an image sensor 1110, a main board 1120, a connector board 1130, and a power board 1140.

The illustrated components are not necessarily required, and a surveillance camera having more or fewer components may be implemented. These components may be implemented as hardware or software, or through a combination of hardware and software. In addition, each component described below may be functionally separated for convenience of description, and one or more components may be implemented as a single chip, a single board, a single control circuit, and/or a plurality of distributed circuits.

The image sensor 1110 may acquire a surveillance image and may operate using power supplied from the power board 1140 to generate a video signal and/or video data. In an embodiment, the power board 1140 may distribute operating power required for the image sensor 1110, the main board 1120, and the connector board 1130 using power supplied from an external network 1150 and/or a separate external power source.

The external network 1150 may be, for example, a network supporting 802.3bt standard, and may supply operating power as well as transmit data. However, the disclosure is not limited thereto, and the external network 1150 may use another Power over Ethernet (PoE) standard or a separate power supply structure other than 802.3bt. IEEE 802.3bt is one of the Power over Ethernet (PoE) standards and is a high-power PoE standard established by IEEE. IEEE 802.3bt supports simultaneous transmission of data and power over an Ethernet cable and may supply up to about 90 W of power, thereby enabling installation without an additional power line and improving wiring and installation efficiency at a camera installation site. However, the technical idea of the disclosure is not limited to a specific power supply standard, and may be applied to any wired or wireless power supply structure capable of supplying power required for operations of the main board 1120, the connector board 1130, and the AI module 1131 in the surveillance camera 1100.

The main board 1120 may be a main video processing device that processes, stores, transmits, and analyzes video data received from the image sensor 1110, and may include the configuration of the data processing unit 1030 of FIG. 4. The main board 1120 may be a main circuit portion that performs basic video acquisition and/or processing functions of the surveillance camera 1100, and may continuously acquire, process, store, and/or transmit video data even while control of the connector board 1130 and the AI module 1131, which will be described later, is being performed. That is, the main board 1120 may be a circuit portion responsible for basic operation of the surveillance camera 1100, and may maintain surveillance functions regardless of an upgrade or a firmware update procedure for the connector board 1130 and the AI module 1131.

The connector board 1130 may be a device responsible for an AI-based portion of video processing in processing the video data received from the main board 1120. In particular, the connector board 1130 may include an interface to which a modular AI computing device is removably connected, and selectively control an operation mode and power supply of the AI computing device under control of the main board 1120, thereby enabling the AI computing device to transition to a state in which firmware thereof is updatable. The connector board 1130 may be configured to selectively control only the power supplied to the AI module 1131 mounted on the interface and the operation mode thereof, while the connector board 1130 itself maintains an operable state.

The main board 1120 and the connector board 1130 may be connected to each other by a first connector of the main board 1120 and a second connector of the connector board 1130, and the first connector and the second connector may support high-speed data transmission such as USB, PCIe, I²C, SPI, or the like. In an embodiment, the connection may include both a high-speed data path for transmitting video data or a firmware image and a digital control signal path for mode setting or power control. That is, a connection structure between the main board 1120 and the connector board 1130 may include one or more data transmission paths and one or more control signal paths, which may be implemented together within the same connector structure or implemented through separate wiring paths or terminals.

The power board 1140 may extract operating power from an external power source and/or an Ethernet-based power supply network connected to a PoE-based external network 1150, as described above, and supply power to the image sensor 1110, the main board 1120, and the connector board 1130. In an embodiment, the power board 1140 may generate and provide power having different voltage or current characteristics for each board and/or each functional block.

The main board 1120 may include a main SoC (or main computing device) 1121, a nonvolatile memory 1122, a network IC 1123, a power module 1124, and a main memory 1125. The main board 1120 may include a circuit configuration for data and power transmission between these components.

The connector board 1130 may include an AI module (or modular computing device) 1131, a nonvolatile memory 1132, a power module 1134, a mode setting logic 1136, and a power control logic 1137. The connector board 1130 may include a circuit configuration for data and power transmission between these components. In an embodiment, the mode setting logic 1136 and the power control logic 1137 may each be implemented as an independent circuit, but in another embodiment, they may be implemented together within a single control IC, a single PMIC, a single complex programmable logic device (CPLD)/FPGA, or a single integrated control circuit.

The main SoC 1121 may function as an ISP that processes video data received from the image sensor 1110, and may control all functions of the camera. The main SoC 1121 may perform system control, data processing, firmware transmission, and/or control of the connector board 1130 in addition to the ISP function. The main SoC 1121 may include all components and functions of the data processing unit 1030 of FIG. 4. The main SoC 1121 may generate a control signal to update firmware of the AI module 1131 without physically separating the AI module 1131 from the interface of the connector board 1130. More specifically, the main SoC 1121 may control the AI module 1131 mounted on the interface such that power cut-off, operation mode transition, power reapplication, firmware image transmission, firmware update, and/or rebooting procedures are sequentially performed while power supplied to the main board 1120 is maintained.

To this end, the main SoC 1121 may read a boot image, an operating system, a control program, a firmware image for operation, and/or a flashing tool for updating the firmware of the AI module 1131 from the nonvolatile memory 1122 and operate based thereon. In an embodiment, the firmware image and the flashing tool may be stored in the nonvolatile memory 1122 of the main board 1120, and in another embodiment, the firmware image or the flashing tool may be received from the external network 1150 or a separate storage device for use.

The main SoC 1121 may transmit or receive a large amount of video data to or from the AI module 1131 in real time through a high-speed interface such as PCIe, Ethernet, USB, and/or the like. In addition, the main SoC 1121 may generate a digital control signal for controlling the mode setting logic 1136 and the power control logic 1137 of the connector board 1130. The digital control signal may be, for example, a General Purpose Input/Output (GPIO) signal, but is not limited thereto, and may be any control signal transmitted through a connector connection structure. Accordingly, the high-speed communication interface may be used as a path for transferring video data, AI processing results, a firmware image, and/or flashing data, and the digital control signal may be used as a separate signal for controlling the mode setting logic 1136 (as a “firmware update mode switching signal” in FIG. 11) and for controlling the power control logic 1137 (as a “AI module power control signal” in FIG. 11).

In addition, the main SoC 1121 may control replacement and upgrading of the AI module 1131 of the connector board 1130 using the digital control signal. A GPIO signal is an electrical control signal transmitted through a general-purpose input/output pin used in a microcontroller or an embedded system, and is used to exchange data with or control an external device by setting these pins as input or output via software. In an embodiment, the main SoC 1121 may transmit the digital control signal to the connector board 1130, and the mode setting logic 1136 of the connector board 1130 may change the state of one or more setting pins of the AI module 1131 according to the control signal to transition to a firmware update mode or a normal operation mode. After the AI module 1131 is set to the firmware update mode, the main SoC 1121 may transmit a firmware image for the AI module 1131 to the connector board 1130 through the high-speed interface. The firmware image may be stored in a local memory of the main board 1120, or may be received through the external network 1150 and used. That is, the main SoC 1121 may perform a series of controls to set the operation mode of the AI module 1131 currently mounted on the interface to the firmware update mode, transmit the firmware image, and return the AI module 1131 to the normal operation mode.

The network IC 1123 may support communication with the external network 1150 to transmit video data, metadata, and analysis data generated in the surveillance camera 1100 to the outside, and/or may receive an external control signal for controlling the surveillance camera 1100.

The power module 1124 may receive power transmitted from the power board 1140 and convert and distribute the received power in a form required by the main board 1120.

The main memory 1125 may temporarily or long-term store data generated by the main SoC 1121.

The AI module 1131 may be a single chip such as a GPU, an NPU, or an AI SoC, which performs AI-based processing on video data transmitted from the main board 1120, or a modular device including such a chip. The AI module 1131 may be mounted on or separated from the connector board 1130 through a removably configured interface provided on the connector board 1130. The removably configured interface for the AI module 1131 on the connector board 1130 may be configured with a form factor supporting various sockets such as SO-DIMM, M.2, MXM, FPC, Samtec, or LGA (Land Grid Array). The socket may be formed according to various standard interface specifications such as SO-DIMM, M.2, MXM, etc., and the AI module 1131 manufactured in conformity with the specification of the socket may be selectively replaced. In some embodiments, particularly relevant examples of standard interface specifications may include SO-DIMM, M.2, and MXM, while other interface forms may also be employed. In addition, although the connector board 1130 may be configured to accommodate one AI module 1131 in one embodiment, a structure in which a plurality of AI modules are respectively mounted through independent sockets is also possible in another embodiment.

The nonvolatile memory 1132 of the connector board 1130 may store an operating system for controlling operations of the connector board 1130 and the AI module 1131, video data received from the main board 1120, and AI applications to be operated by the AI module 1131. In an embodiment, the nonvolatile memory 1132 of the connector board 1130 may store firmware or setting information for driving control logic on the connector-board side. In addition, the nonvolatile memory 1132 may store status information, operation settings, and/or update-related auxiliary information of the currently mounted AI module 1131.

The power module 1134 may receive power transmitted from the power board 1140 and convert and distribute the received power in a form required by the connector board 1130. In addition, the power module 1134 may interrupt or provide operating power to the AI module 1131 according to a control signal of the power control logic 1137. That is, while the connector board 1130 itself maintains an operable state, only the power supplied to the AI module 1131 through the interface may be selectively interrupted or provided. The power control logic 1137 may include at least one of a power switching element and a power management circuit, such as a linear regulator, a MOSFET switch, or a PMIC, and may independently supply or cut off power to the AI module 1131 according to an AI module power control signal included in a digital control signal such as a GPIO signal received from the main SoC 1121. In this way, in an embodiment of the disclosure, since it is possible to selectively control only the operating power supplied to the AI module 1131 mounted on the interface rather than cutting off power to the entire connector board 1130, the boot state of the AI module 1131 may be reset while the control function of the connector board 1130 is maintained.

The mode setting logic 1136 may change an input or output pin setting of the AI module 1131 according to a firmware update mode conversion signal included in a digital control signal such as a GPIO signal received from the main SoC 1121, thereby making it possible to perform flashing of a firmware image for the AI module 1131 mounted on the interface, including a newly installed replacement module and/or an already mounted module. The mode setting logic 1136 may be configured to apply a control signal to one or more setting pins that determine a boot mode or an operation mode of the AI module 1131, thereby causing the AI module 1131 to transition to a firmware update mode or a normal operation mode. When flashing of the firmware image for the AI module 1131 is completed, the mode setting logic 1136 may change the AI module 1131 back to the normal operation mode. That is, the main SoC 1121 may transmit a control signal for setting an operation mode (e.g., normal operation mode or firmware update mode) of the AI module 1131 to the mode setting logic 1136 of the connector board 1130, and the mode setting logic 1136 may change a pin setting for mode selection of the AI module 1131 according to the control signal. Thereafter, if needed, the power supplied to the AI module 1131 may be cut off again and then reapplied to the AI module 1131, and power is supplied again such that the surveillance camera may continue operating with the upgraded AI module. Here, a higher-performance replacement AI module is merely an example, and control by the mode setting logic 1136 may be applied not only to a replaced AI module but also to re-flashing or resetting of an already mounted AI module. In addition, the mode setting logic 1136 may control one or more bootstrap pins, setting pins, and/or similar mode determination signal lines, thereby causing the AI module 1131 to enter a boot state suitable for a firmware update or a normal AI inference state.

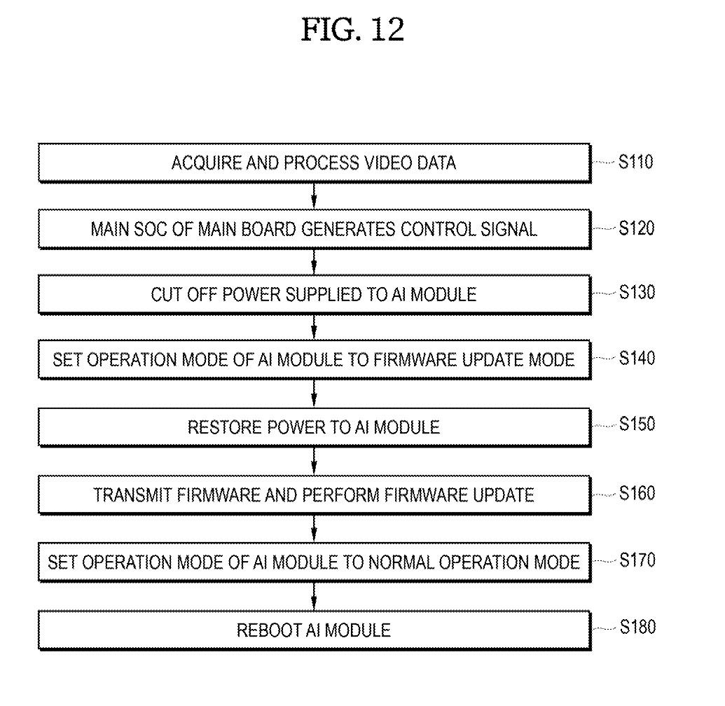

To summarize, the upgrade or firmware update process of the AI module 1131 in the surveillance camera according to the disclosure may be performed as follows. First, the main SoC 1121 of the main board 1120 may transmit a control signal to the power control logic 1137 of the connector board 1130 to cut off power supply to the AI module 1131. In an embodiment, an operator at the installation site of the camera may remove the existing AI module 1131 from the removably configured interface of the connector board 1130 and mount a new AI module 1131. In another embodiment, the AI module 1131 that is already mounted may be firmware-updated as it is without being physically separated. The main SoC 1121 may transmit a control signal to the mode setting logic 1136 to change the AI module 1131 currently mounted on the interface to a firmware update mode, and then transmit a control signal to the power control logic 1137 to supply power to the AI module 1131. At this time, the supplied power may not be supplied to the entire connector board 1130, but rather operating power supplied to the AI module 1131 through the interface. Thereafter, the main SoC 1121 may update the firmware (for example, by firmware flashing) for the AI module 1131 through the high-speed communication interface. When the firmware update is completed, finally, the main SoC 1121 may transmit a control signal to the mode setting logic 1136 to change the AI module 1131 to the normal operation mode, and then cut off and reapply the power to the AI module 1131. That is, based on the configuration of FIG. 11, power cut-off, operation mode transition, power reapplication, firmware update, and/or rebooting may be performed only for the AI module 1131 mounted on the interface while power supply to the main board 1120 is maintained. Based on this configuration, a method of operating a video processing apparatus may be performed, which will be described below with reference to FIG. 12.

By performing upgrading of the AI module 1131 as described above, the main board 1120 may continuously acquire video data from the image sensor 1110 to process, store, and/or transmit the video data even during the process of controlling and updating the connector board 1130 and the AI module 1131. Therefore, according to the disclosure, a user may selectively apply AI modules 1131 of different performance levels without excessively increasing the basic specifications of the main board 1120, and may expand and/or upgrade AI functions without cutting off power to the entire surveillance camera. Furthermore, according to the disclosure, problems of resource shortage, increased heat generation, and increased cost that may occur due to excessive dependence on an AI function inside the main SoC may be mitigated, an upgrade limitation that may occur in an AI chip structure fixedly mounted on a main board may be reduced, and maintenance and performance expansion of a modular AI computing function may be performed more easily at an installation site without a separate external jig device or complicated re-installation procedure.

In addition, an arrangement of the main board 1120, the connector board 1130, the power control logic 1137, and the mode setting logic 1136 described in an embodiment of the disclosure is merely an example, and these components may be distributed over one or more boards or implemented as partially integrated control circuitry. Similarly, the firmware update of the AI module 1131 may be applied to an initial setting process for a replaced module, or may be applied to a re-flashing process for an already mounted module.

FIG. 12 is a flowchart illustrating a method of operating a video processing apparatus according to an embodiment.

Each operation described with reference to FIG. 12 is performed through coordinated control of the respective components in the main board 1120 and the connector board 1130 of FIG. 11.

Referring to FIGS. 11 and 12, first, the main board 1120 may process video data received from the image sensor 1110 (S110). This operation may be performed with an uninterrupted video acquisition and processing according to the disclosure. Even during the entire process in which control of the connector board 1130 and firmware update of the AI module 1131, which will be described later, is performed, the main board 1120 may continuously acquire, process, store, and/or transmit video data without interruption. That is, even while a firmware update and/or rebooting process of the AI module 1131 is in progress, the main board 1120 may continue to maintain basic video acquisition and processing functions of the surveillance camera. Therefore, the disclosure may reduce loss of surveillance footage even during firmware updating and/or replacement of the AI module 1131, and may enable on-site maintenance without cutting off power to the entire system.

Subsequently, while power supply to the main board 1120 is maintained and the connector board 1130 is in an operable state, the main SoC 1121 of the main board 1120 may generate a control signal (S120). The control signal may be transmitted to the power control logic 1137 and the mode setting logic 1136 of the connector board 1130 to sequentially control subsequent procedures of power cut-off, operation mode transition, power reapplication, and/or firmware update.

When the control signal is generated in S120, the power control logic 1137 of the connector board 1130 may cut off power supply to the existing AI module 1131 mounted on the interface in response thereto (S130). Here, the interface may be a removable socket for the AI module 1131 formed according to a standard interface specification such as SO-DIMM, M.2, and MXM. At this time, independently of the power state of the main SoC 1121, only the operating power supplied to the AI module 1131 through the interface may be selectively cut off. That is, only power supplied to the AI module 1131 mounted on the interface may be controlled while the main board 1120 and the connector board 1130 continue to maintain an operable state. In an embodiment, after power supply to the AI module 1131 is cut off, the previously mounted AI module 1131 may be physically detached from the interface, and another AI module 1131 for replacement may be mounted on the interface. However, this physical detachment and mounting process is merely an example, and the technical idea of the disclosure may also be applied to a case where firmware is updated without physically separating the AI module 1131 mounted on the interface.

If needed, while the power to the AI module 1131 remains cut off, the previously mounted AI module 1131 may be removed, and a replacement AI module 1131 may be mounted on the interface.

Next, according to the control signal, the mode setting logic 1136 of the connector board 1130 may set the operation mode of the AI module 1131 mounted on the interface to a firmware update mode (S140). Specifically, the mode setting logic 1136 may apply the control signal received from the main SoC 1121 to one or more setting pins determining the operation mode of the AI module 1131 mounted on the interface, thereby placing the system in a state suitable for firmware updating at the hardware level. By switching the operation mode in this way, the AI module 1131 may be set to a boot state suitable for firmware writing or flashing, rather than a normal operating state.

After the operation mode transition is completed, the power control logic 1137 may restore power to the AI module 1131 mounted on the interface (S150). Through this, the AI module 1131 mounted on the interface may enter a boot state corresponding to the firmware update mode, and may be in a state capable of undergoing a subsequently performed firmware writing procedure.

When the power is reapplied, the main SoC 1121 may transmit firmware to the AI module 1131 mounted on the interface to update the firmware (S160). Transmission of the firmware may be performed through a high-speed communication interface between the main board 1120 and the connector board 1130, and the high-speed communication interface may include, for example, USB, PCIe, Ethernet, I²C, SPI, or a combination thereof. In an embodiment, the update may be independently performed based on at least one of firmware stored in a memory of the main board 1120 or a flashing tool for updating the firmware, without a connection to separate external equipment. Alternatively, in another embodiment, the firmware may be provided from an external server or a storage device and then transmitted to the AI module 1131 through the main board 1120. With the above configuration, a user may selectively mount AI modules 1131 with different specifications according to the required AI performance, and expand AI functionality without changing the main SoC 1121 of the main board 1120 to a higher-performance specification.

After the firmware update is completed, the mode setting logic 1136 may change a signal applied to the setting pin to reset the operation mode of the AI module 1131 mounted on the interface back to the normal operation mode (S170). This operation may be an operation of returning the AI module 1131 to a normal operating mode such that the AI module 1131 may perform AI inference or video analysis functions in an actual operating state after firmware writing has been completed.

Finally, the power control logic 1137 may cut off and then reapply power to the AI module 1131 mounted on the interface to reboot the AI module 1131 mounted on the interface (S180). Through this, normal start-up may be achieved in the normal operation mode with the updated firmware reflected, and the newly updated or replaced AI module 1131 may normally return to the main system to resume AI processing. That is, according to an embodiment of the disclosure, while the main board 1120 continues video processing in a state where power supply is maintained, the connector board 1130 may selectively perform power cut-off, operation mode transition, power reapplication, firmware update, and/or rebooting only for the AI module 1131 mounted on the interface, thereby enabling replacement or upgrade of the AI module 1131 without stopping operation of the entire surveillance camera.

According to an aspect of an example embodiment of the disclosure, a video processing apparatus, including: a first circuit portion including a first computing device configured to process video data received from an image sensor; and a second circuit portion configured to receive a control signal from the first circuit portion and including an interface on which a second computing device is removably mounted, wherein the second circuit portion includes: a power supply control circuit configured to, in response to the control signal, control power supplied to the second computing device through the interface, independently of power supplied to the first circuit portion; and an operation mode setting circuit configured to, in response to the control signal, set an operation mode of the second computing device to a firmware update mode or a normal operation mode, wherein, in the firmware update mode, the first computing device is configured to perform updating a firmware of the second computing device while the power supplied to the first circuit portion is maintained and the second circuit portion is operable.

The power supply control circuit may be configured to cut off the power supplied to the second computing device in response to the control signal, and in the firmware update mode, the power supply control circuit may be configured to restore power to the second computing device.

The operation mode setting circuit may be configured to apply the control signal to one or more setting pins of the second computing device to set the operation mode of the second computing device to the firmware update mode or the normal operation mode.

In the firmware update mode, the first circuit portion may be configured to continuously process the video data.

The interface may include a socket that conforms to a standard interface specification.

The socket may conform to at least one of Small Outline Dual In-Line Memory Module (SO-DIMM), M.2, and Mobile PCI Express Module (MXM) standard interface specifications.

The first circuit portion may include a memory configured to store at least one of the firmware of the second computing device and a flashing tool for updating the firmware, and the first circuit portion may be configured to transmit the firmware to the second computing device via a high-speed communication interface between the first circuit portion and the second circuit portion.

The first computing device may be configured to update the firmware of the second computing device without physically separating the second computing device from the interface.

According to an aspect of an example embodiment of the disclosure, a video processing apparatus, including: an image sensor configured to acquire a video signal; a main board including a main computing device configured to transmit video data generated based on the video signal; and a connector board connected to the main board via a communication interface and including a socket on which a modular computing device is removably mounted, the modular computing device being configured to process the video data received from the main board via the communication interface, wherein the connector board includes: a power control logic configured to, in response to a control signal received from the main board via the communication interface, control power supplied through the socket to the modular computing device, independently of power supplied to the main board; and a mode setting logic configured to, in response to the control signal, set an operation mode of the modular computing device to a firmware update mode or a normal operation mode, and wherein, in the firmware update mode, the connector board is configured to update a firmware of the modular computing device without physically separating the modular computing device from the socket, while the power supplied to the main board is maintained and the connector board is operable.

The socket may conform to a standard interface specification.

The socket may conform to at least one of Small Outline Dual In-Line Memory Module (SO-DIMM), M.2, and Mobile PCI Express Module (MXM) standard interface specifications.

The power control logic may include at least one of a power switching element and a power management circuit, and may be configured to selectively interrupt or provide the power supplied through the socket to the modular computing device.

The mode setting logic may be configured to apply the control signal to one or more setting to set the operation mode of the modular computing device to the firmware update mode or the normal operation mode.

In the firmware update mode, the main board may be configured to continuously transmit the video data.

According to an aspect of an example embodiment of the disclosure, a method of operating a video processing apparatus, the method including: processing, by a first circuit portion, video data received from an image sensor; generating, by a first computing device of the first circuit portion, a control signal; controlling, by a power supply control circuit of a second circuit portion in response to the control signal, power supplied to a second computing device mounted on an interface of the second circuit portion; setting, by an operation mode setting circuit of the second circuit portion in response to the control signal, an operation mode of the second computing device to a normal operation mode or a firmware update mode; and updating, by the first computing device in the firmware update mode, a firmware of the second computing device while power to the first circuit portion is maintained and a second circuit portion is operable.

The controlling the power may include: cutting off, by the power supply control circuit in response to the control signal, the power supplied to the second computing device; and subsequently restoring, by the power supply control circuit, the power supplied to the second computing device, in the firmware update mode, and the updating the firmware may include: transmitting, by the first computing device in the firmware update mode, the firmware to the second computing device to update the firmware.

The method may further include, after the updating the firmware: setting, by the operation mode setting circuit, the operation mode of the second computing device to the normal operation mode; and cutting off and then reapplying, by the power supply control circuit, the power supplied to the second computing device to reboot the second computing device.

The setting the operation mode may include applying the control signal to one or more setting pins of the second computing device to set the operation mode of the second computing device to the firmware update mode or the normal operation mode.

The updating the firmware may include: transmitting, by the first computing device in the firmware update mode, the firmware to the second computing device via a high-speed communication interface between the first circuit portion and the second circuit portion; and updating the firmware based on at least one of a firmware stored in a memory of the first circuit portion and a flashing tool for updating the firmware.

The processing the video data may include continuously processing the video data in the firmware update mode.

Accordingly, according to one or more embodiments of the disclosure, by selectively controlling the power supply and the operation mode for the modular computing device mounted on the interface while maintaining the power supply to the mainboard of the surveillance camera, the firmware update, reboot, replacement and/or upgrade of the modular computing device may be performed without shutting down the power to the entire surveillance camera.

Further, according to one or more embodiments of the disclosure, the functions of acquiring, processing, storing, and/or transmitting video of the surveillance camera may be continued even while the update or replacement of the modular computing device is being performed, thereby reducing or avoiding the omission of surveillance video or security issue.

Further, according to one or more embodiments of the disclosure, the user may selectively apply modular computing devices of different specifications according to the required AI processing performance, thereby flexibly expanding AI functions without excessively increasing the basic hardware specifications and cost of the mainboard.

Further, according to one or more embodiments of the disclosure, problems such as resource shortage, increased heat generation, and increased cost caused by excessive dependence on AI functions inside the main SoC may be mitigated, and upgrade limitations that may occur in an AI chip structure fixedly mounted on a mainboard may be reduced.

Further, according to one or more embodiments of the disclosure, it is possible to more easily perform initialization, firmware update, and restart of the modular computing device at the installation site while reducing dependence on a separate external jig device or a complicated installation environment.

The effects obtainable in the disclosure are not limited to the foregoing, and other effects not expressly set forth herein will be apparent to those skilled in the art from the following description.

The video processing apparatus of the present specification may be related to at least one or more of a surveillance camera, an autonomous vehicle, a user terminal, and a server, and may also be associated with an artificial intelligence (AI) module, a robot, an augmented reality (AR) device, a virtual reality (VR) device, and a device related to a 5G service and a 6G service, or the like.

For understanding of the disclosure, reference signs are used in embodiments shown in the drawings, and specific terms are used to describe the embodiments, but the disclosure is not limited by the specific terms and the disclosure may include all components that may be commonly conceived by one of ordinary skill in the art.

The disclosure may be represented by functional block configurations and various processing operations. The functional blocks may be implemented by various numbers of hardware and/or software configurations that perform particular functions. For example, the disclosure may employ integrated circuit configurations, such as memories, processors, logics, and look-up tables, which may execute various functions under control by one or more microprocessors or other control devices. Like components of the disclosure being implemented by software programming or software elements, the disclosure may be implemented in programming or scripting language, such as C, C+, Java, or assembler, by including various algorithms implemented by a combination of data structures, processes, routines, or other programming configurations. Functional aspects may be implemented by algorithms executed in one or more processors. In addition, the disclosure may employ general techniques for electronic environment setting, signal processing, and/or data processing. Terms such as “mechanism”, “element”, “means”, and “configuration” may be used widely and are not limited as mechanical and physical configurations. The terms may include a meaning of a series of routines of software in association with a processor or the like.

Certain executions described in the disclosure are embodiments and do not limit the scope of the disclosure in any way. For brevity of the specification, general electronic configurations, control systems, software, and other functional aspects of systems may be omitted. In addition, connection or connection members of lines between components shown in the drawings exemplarily represent functional connections and/or physical or circuit connections, and in an actual apparatus, may be replaced or may be implemented as various additional functional connections, physical connections, or circuit connections. Also, components described herein may not be essential components for application of the disclosure unless the components are particularly described as being “essential” or “critical”.

The term “the” and similar referential terms in the specification (specifically in the claims) of the disclosure may be used for both the singular and the plural. Further, when a range is described in the disclosure, the disclosure includes inventions to which individual values belonging to the range are applied (unless otherwise stated), and it is considered that each individual value in the range is described in the detailed description of the disclosure. Lastly, unless an order is clearly stated or unless otherwise stated, operations of a method according to the disclosure may be performed in an appropriate order. The disclosure is not necessarily limited by an order the operations are described.

What is claimed is:

1. A video processing apparatus, comprising:
a first circuit portion comprising a first computing device configured to process video data received from an image sensor; and
a second circuit portion configured to receive a control signal from the first circuit portion and comprising an interface on which a second computing device is removably mounted,
wherein the second circuit portion comprises:
a power supply control circuit configured to, in response to the control signal, control power supplied to the second computing device through the interface, independently of power supplied to the first circuit portion; and
an operation mode setting circuit configured to, in response to the control signal, set an operation mode of the second computing device selectively to a firmware update mode or a normal operation mode,
wherein, in the firmware update mode, the first computing device is configured to perform updating a firmware of the second computing device while the power supplied to the first circuit portion is maintained and the second circuit portion is operable.

2. The video processing apparatus of claim 1, wherein the power supply control circuit is configured to cut off the power supplied to the second computing device in response to the control signal, and
wherein, in the firmware update mode, the power supply control circuit is configured to restore power to the second computing device.

3. The video processing apparatus of claim 2, wherein the operation mode setting circuit is configured to apply the control signal to one or more setting pins of the second computing device to set the operation mode of the second computing device selectively to the firmware update mode or the normal operation mode.

4. The video processing apparatus of claim 1, wherein, in the firmware update mode, the first circuit portion is configured to continuously process the video data.

5. The video processing apparatus of claim 1, wherein the interface comprises a socket that conforms to a standard interface specification.

6. The video processing apparatus of claim 5, wherein the socket conforms to at least one of Small Outline Dual In-Line Memory Module (SO-DIMM), M.2, and Mobile PCI Express Module (MXM) standard interface specifications.

7. The video processing apparatus of claim 1, wherein the first circuit portion comprises a memory configured to store at least one of the firmware of the second computing device and a flashing tool for updating the firmware, and
wherein the first circuit portion is configured to transmit the firmware to the second computing device via a high-speed communication interface between the first circuit portion and the second circuit portion.

8. The video processing apparatus of claim 1, wherein the first computing device is configured to update the firmware of the second computing device without physically separating the second computing device from the interface.

9. A video processing apparatus, comprising:
an image sensor configured to acquire a video signal;
a main board comprising a main computing device configured to transmit video data generated based on the video signal; and
a connector board connected to the main board via a communication interface and comprising a socket on which a modular computing device is removably mounted, the modular computing device being configured to process the video data received from the main board via the communication interface,
wherein the connector board comprises:
a power control logic configured to, in response to a control signal received from the main board via the communication interface, control power supplied through the socket to the modular computing device, independently of power supplied to the main board; and
a mode setting logic configured to, in response to the control signal, set an operation mode of the modular computing device selectively to a firmware update mode or a normal operation mode, and
wherein, in the firmware update mode, the connector board is configured to update a firmware of the modular computing device without physically separating the modular computing device from the socket, while the power supplied to the main board is maintained and the connector board is operable.

10. The video processing apparatus of claim 9, wherein the socket conforms to a standard interface specification.

11. The video processing apparatus of claim 10, wherein the socket conforms to at least one of Small Outline Dual In-Line Memory Module (SO-DIMM), M.2, and Mobile PCI Express Module (MXM) standard interface specifications.

12. The video processing apparatus of claim 9, wherein the power control logic comprises at least one of a power switching element and a power management circuit, and is configured to selectively interrupt or provide the power supplied through the socket to the modular computing device.

13. The video processing apparatus of claim 9, wherein the mode setting logic is configured to apply the control signal to one or more setting to set the operation mode of the modular computing device selectively to the firmware update mode or the normal operation mode.

14. The video processing apparatus of claim 9, wherein, in the firmware update mode, the main board is configured to continuously transmit the video data.

15. A method of operating a video processing apparatus, the method comprising:
processing, by a first circuit portion, video data received from an image sensor;
generating, by a first computing device of the first circuit portion, a control signal;
controlling, by a power supply control circuit of a second circuit portion in response to the control signal, power supplied to a second computing device mounted on an interface of the second circuit portion;
setting, by an operation mode setting circuit of the second circuit portion in response to the control signal, an operation mode of the second computing device selectively to a normal operation mode or a firmware update mode; and
updating, by the first computing device in the firmware update mode, a firmware of the second computing device while power to the first circuit portion is maintained and a second circuit portion is operable.

16. The method of claim 15, wherein the controlling the power comprises:
cutting off, by the power supply control circuit in response to the control signal, the power supplied to the second computing device; and
subsequently restoring, by the power supply control circuit, the power supplied to the second computing device, in the firmware update mode, and
wherein the updating the firmware comprises:
transmitting, by the first computing device in the firmware update mode, the firmware to the second computing device to update the firmware.

17. The method of claim 16, further comprising, after the updating the firmware:
setting, by the operation mode setting circuit, the operation mode of the second computing device to the normal operation mode; and
cutting off and then reapplying, by the power supply control circuit, the power supplied to the second computing device to reboot the second computing device.

18. The method of claim 16, wherein the setting the operation mode comprises applying the control signal to one or more setting pins of the second computing device to set the operation mode of the second computing device to the firmware update mode or the normal operation mode.

19. The method of claim 16, wherein the updating the firmware comprises:
transmitting, by the first computing device in the firmware update mode, the firmware to the second computing device via a high-speed communication interface between the first circuit portion and the second circuit portion; and
updating the firmware based on at least one of a firmware stored in a memory of the first circuit portion and a flashing tool for updating the firmware.

20. The method of claim 15, wherein the processing the video data comprises continuously processing the video data in the firmware update mode.
